(19) United States
(12) Patent Application Publication
(10) Pub. No.: US 2003/0055721 A1
(43) Pub. Date: Mar. 20, 2003

(54) System for delivery of consumer-selected promotional savings

(76) Inventor: Edward L. Beery II, Centennial, CO (US)

Correspondence Address: EDWARD L. BEERY II, 2830 E. PEAKVIEW AVE., CENTENIAL, CO, 80121, US

(21) Appl. No.: 09/954,823

(22) Filed: Sep. 18, 2001

(51) Int. Cl. G06F 17/60

(52) U.S. Cl. 705/14; 705/26

(57) ABSTRACT

Method for delivery of consumer selected promotional offers via a local printer or electronic retrieval. Records containing the criteria for promotional offers are compared to records of consumer entered, planned purchases. If the promotional criteria are met, the promotional offer or offers are presented to the consumer for consideration. The consumer may actively select promotions of interest. Promotions selected by the consumer are stored within a record. Products and product quantities on the order are adjusted for promotions designed to changed products within the order. The consumer-selected promotions are then made available for printing using the consumer's home PC and printer or via electronic retrieval.

### BACKGROUND

1. Field of Invention

The present invention relates to a computer method and more particularly a system for promotional marketing efforts aimed at specific consumers based on real-time, consumer entered, planned purchase information wherein the consumer actively selects the promotions that are of interest to them, the selected promotions are electronically stored and the promotions are either printed on the consumer's printer or electronically retrieved.

2. Prior Art

Many manufacturers distribute discount coupons for their products via “conventional methods”, either through the mail, or by printing them in newspapers or magazines, or enclosing them in the product package or in similar or related product packages. When a customer presents a discount coupon at the time of purchase of an appropriate product, the employee operating the terminal will either key in the coupon amount or scan the coupon barcode, and the discount will be subtracted from the customer's bill. These conventional methods for coupon distribution have a number of disadvantages:

a) The product coupons are distributed to a person who has previously bought the same or a related product. This method does little to increase the number of customers who buy a particular product.

b) People who collect coupons from newspapers and mailings typically fall into a very narrow group, motivated to collect coupons of any kind, usually for economic reasons.

c) Customers who collect and redeem a particular coupon will usually have had some prior knowledge of the product and are probably not “new” customers.

d) This method requires a significant effort in terms of time and organization on the part of the consumer.

e) The coupon may be offered at a time when the consumer has no immediate need for the product.

f) The manufacturer, regardless of the consumer's interest in the coupon, must cover the cost of the coupon distribution.

g) The significant number of unused coupons add to waste and ultimately become garbage.

Another strategy used to reach customers is mass mailings of free samples of the product, together with discount coupons. The consumer may then clip the coupon and return to the appropriate retail location to purchase the promoted item and redeem the coupon. The mass mailing method has a number of disadvantages:

a) Mass mailing promotions are very expensive.

b) Free samples of some types of products cannot be conveniently mailed.

c) Many potential new customers may ignore the mass mailing.

d) Mass mailing advertising may fail to reach a potential new customer, or convince them to try a new product, especially if they are already relatively satisfied with a competitive product.

e) The mailing may come at a time when the consumer has no immediate need for the product.

f) The mass approach to coupon distribution reaches some consumers that would never have any interest in the promoted item. A childless couple will have no use for a sample and accompanying coupon for diapers.

g) The manufacturer, regardless of the consumer's interest in the coupon and product, must cover the mass mailing cost.

h) Any unused coupons and product samples add to waste and ultimately become garbage.

A refinement of the mass mailing method is the targeted mailing method. With this method, specific demographic information is used to “target” specific households in an effort to improve the chances that a household will have interest in the promoted item. An example of a targeted mailing is the use of birth records to create a list of households with new babies. The targeted mailing method has the following disadvantages:

a) The promoting company runs the risk of damaging relations with the consumer in the event of significant changes within the household. Using the above new baby example, a newborn on a “birth list” may have passed away in the first months of life. Manufacturers have legitimate concerns of sending a diaper coupon to a household that has experienced such a tragedy.

b) Manufacturers must pay for the information on target marketing lists.

c) The information used for target marketing may still not reach all consumers with interest in the promoted product and may reach consumers with no interest in the promoted product.

d) Consumers are very concerned with privacy and may not like receiving such unsolicited and targeted promotions.

e) The targeted consumer does not participate in the selection of the promotion and may have no interest in the promoted item.

f) The targeted mailing may come at a time when the consumer has no immediate need for the product.

g) Targeted mailings tend to be very expensive due to costs for the consumer information, the material to be mailed, the delivery of the material and the promotion savings costs.

h) The manufacturer, regardless of the consumer's interest in the coupon and product, must cover the cost of the targeted mailing.

Another alternative is point-of-sale coupon systems that leverage “trigger” items during the retail checkout process. “Trigger” items are items that are associated with promotions. The promotions are triggered when a check stand at a retail location registers the purchase of a triggering item. With this technique, a promotion may also be triggered if a triggering item is not found during the checkout process. This “post purchase” method has a number of disadvantages:

a) The targeted consumer does not receive the coupon until after a competitive product has been purchased.

b) The purchase frequency (days between purchase of a specific item type) of some products may require the consumer to hold the point of sale printed coupon for many weeks before redemption. For example, the average consumer does not have a need to purchase laundry detergent on every visit to the store. A laundry promotion provided by the point-of-sale method may not be needed for the consumer for some time, thus reducing the effectiveness of the promotion.

c) The manufacturer has already lost the opportunity to sell the consumer on this purchase occasion.

d) The consumer does not participate in the selection of the coupon and may receive coupons that are of no interest to the consumer.

e) The manufacturer must pay the distribution charge, even if the consumer has no intention of redeeming the coupon.

There are also Internet methods used for the delivery of promotions. Three types of promotion delivery are currently available on the Internet. The “order coupons” method is very similar to the conventional method previously mentioned. With the order coupons method, a consumer uses a web page to look at coupon offers available and selects from the list provided. Once the consumer has finished selecting coupons, they place an order for the coupons and the coupons are delivered to the consumer. This method has most of the disadvantages of the traditional method.

a) People who collect coupons this way will typically fall into a very narrow group who are motivated to collect coupons of any kind, usually for economic reasons.

b) Customers who collect and redeem a particular coupon will usually have had some prior knowledge of the product and are probably not “new” customers.

c) The promotion may be offered at a time when the consumer has no immediate need for the product.

d) Like the conventional method, this method requires a significant effort in terms of time and organization on the part of the consumer. The time issue with this method however, is more significant than with the traditional method. The consumer must be willing to wait up to ten days before receiving the selected coupons.

Another Internet method for promotional distribution is the same as the order coupons method with the only difference being that the selected coupons are printed on the consumer's printer. This method has all of the disadvantages of the order coupons method listed above except the additional ten day waiting period is eliminated.

The third Internet promotional delivery method, the “voucher” method, involves a consumer selecting from a list of promotions. When the consumer has finished selecting promotions, a machine-readable document is printed that serves as a record of the promotions selected by the consumer. The consumer then takes the document to a participating retailer and presents the document at the check stand. If the consumer purchases products associated with the selected promotions, they receive a voucher for the savings offered for the consumer's use on their next shopping trip. The voucher or vouchers are printed with the receipt and given to the consumer as they exit the store. The consumer may present the voucher on their next visit to a participating retailer and the savings will be removed from the order total regardless of the contents of the order. The voucher method has a number of disadvantages:

a) People who participate will typically fall into a very narrow group who are motivated to collect coupons of any kind, usually for economic reasons.

b) Customers who select a particular promotion will usually have had some prior knowledge of the product and are probably not “new” customers.

c) Like the conventional method, this method requires a significant effort in terms of time and organization on the part of the consumer.

d) The promotion may be offered at a time when the consumer has no immediate need for the product.

e) The consumer does not recognize the promotional savings until their next visit to the retailer. The consumer receives the voucher with the sales receipt for the order as they exit the store. The consumer must then bring the voucher back to the store on a subsequent visit to realize the promotional savings.

f) The vouchers offered are accepted by a limited number of retailers.

The delivery of a promotional offer to a consumer based on the consumer's planned, immediate purchases, before the consumer has purchased any product, with the savings recognized at the time of purchase, would be ideal. The solution would also allow the consumer to actively participate in the selection of the promotions offered.

### OBJECTS AND ADVANTAGES

The applicant is unaware of the existence of any system that addresses the above-described shortcomings in the prior art. Therefore, several objects and advantages of the present invention are:

a) to provide a consumer-driven system;

b) to provide a system allowing consumers to view promotional offers;

c) to provide a system allowing consumers direct participation in the acceptance of a promotional offer;

d) to provide a system allowing consumers direct participation in the denial of a promotional offer;

e) to provide a system for electronic storage of consumer promotion selections for electronic retrieval;

f) to provide a system allowing manufacturers to select from one to many trigger products for promotional offers to consumers;

g) to provide a system allowing retailers to select from one to many trigger products for promotional offers to consumers;

h) to provide a system allowing external organizations to select from one to many trigger products for promotional offers to consumers;

i) to provide a system for “present” trigger products where the promotion is offered to the consumer based on the existence of trigger products on the consumer's order;

j) to provide a system for “not present” trigger products where the promotion is offered to the consumer based on the lack of trigger products on the consumer's order;

k) to provide a system for “multiple” product triggers where the promotion is offered to the consumer based on the existence of two or more trigger products on the consumer's order;

l) to provide a system to allow “replacement” offers that, when selected by the consumer, replace a trigger product with a user entered quantity of a user selected promotional product on an order;

m) to provide a system to allow “enhancement” offers that, when selected by the consumer, add a user selected product to an order;

n) to provide a system to allow “external” offers that, when selected by the user, provide the user with a coupon printed via the consumer's home PC printer for use at a third party organization;

o) to provide a system with flexibility to allow the creation of any number of promotional types that may be added at any time in the future;

p) to provide a system to create home PC printed coupons of promotional offers selected by the consumer;

q) to provide a system to deliver consumer-selected promotion savings to a machine readable coupon;

r) to provide a system to create data driven, machine readable, bar-coded coupons, printed on home PC printers, that fulfill the Uniform Code Council specification for coupons;

s) to provide a system to allow unique IDs for printed coupons;

t) to provide a system to allow coupon IDs for printed coupons;

u) to provide a system to allow coupon codes for printed coupons;

v) to provide a system to allow coupon extended codes for printed coupons;

w) to provide a system to allow coupon expiration dates for printed coupons;

x) to provide a system to offer promotional savings to a single store;

y) to provide a system to offer promotional savings to a specified group of stores;

z) to provide a system to offer promotional savings to a specified geographical selling area;

aa) to provide a system to offer promotional savings to an entire marketing area; and

bb) to provide a system that protects consumer privacy by forwarding promotional offers based solely on previously defined criteria where no person must view a consumer's order content to forward the promotions.

Further objects and advantages are to provide for the existence of a promotional offer based on the presence or lack of presence of a trigger product or products indicating the desire of the consumer to participate in the use of a product, eliminating concern of misdirected marketing efforts, significantly reducing marketing material waste, significantly reducing misdirected marketing expenditures, allowing for promotional offers for products clearly associated with products the consumer intends to buy within an immediate time frame, providing high confidence for marketing programs aimed at consumers based on real time analysis of current consumer planned purchases, allowing access to the consumer purchase decision before the purchase decision is consummated, reducing the time distance between the presentation of a promotional offer and the consumer's purchase of a product, significantly reducing the organization effort required by the consumer to take advantage of promotional offers, allowing the consumer to participate in the acceptance or refusal of a promotional offer, and maintaining the consumer's privacy via planned purchase assessment facilitated without human intervention at the order level. Additional objects and advantages will become apparent from a consideration of the drawings and ensuing description.

### DESCRIPTION OF DRAWINGS

FIG. 1 is a simplified drawing of the principle data elements of the invention;

FIG. 2 is a simplified drawing of the computer hardware required for the invention;

FIG. 3 is a block diagram illustrating the interrelationships between the principle files used in the apparatus of the invention;

FIG. 4 is a simplified flow chart showing the functions performed to organize triggered promotion(s) prior to printing;

FIG. 5 is a simplified flow chart showing the functions performed to evaluate the consumer's selection or lack of selection of promotions presented to the user;

FIG. 6 is a simplified flow chart showing the functions performed to print the promotions selected by the consumer;

FIG. 7 shows a coupon with a scan-able barcode that meets Uniform Code Council standards;

FIG. 8 shows a coupon without a scan-able barcode.

### SUMMARY

The present invention provides a method for printing consumer selected promotional offers via a local printer. In general terms, the apparatus of the invention comprises (1) means for storing criteria for promotional offers, (2) means for comparison of stored promotion criteria to stored consumer entered planned purchase information, (3) means for presenting promotional offers to consumers if the promotional criteria are satisfied, (4) means for a consumer to select from the promotions offered, (5) means for storing consumer promotional selections, (6) means for adjusting order products and quantities in response to consumer promotion choices and (7) means for printing the consumer selected promotional offers via a local printer.

Another embodiment of the present invention provides a method for the storage of consumer selected promotional offers for use with a typical retail checkout terminal. In general terms, the apparatus of the invention comprises (1) means for storing criteria for promotional offers, (2) means for comparison of stored promotion criteria to stored consumer entered planned purchase information, (3) means for presenting promotional offers to consumers if the promotional criteria are satisfied, (4) means for a consumer to select from the promotions offered, (5) means for storing consumer promotional selections, (6) means for adjusting order products in response to consumer promotion choices whereby the stored promotional selections may be retrieved electronically, thereby allowing the promotional offer to be realized by the consumer via a retail check-out terminal.

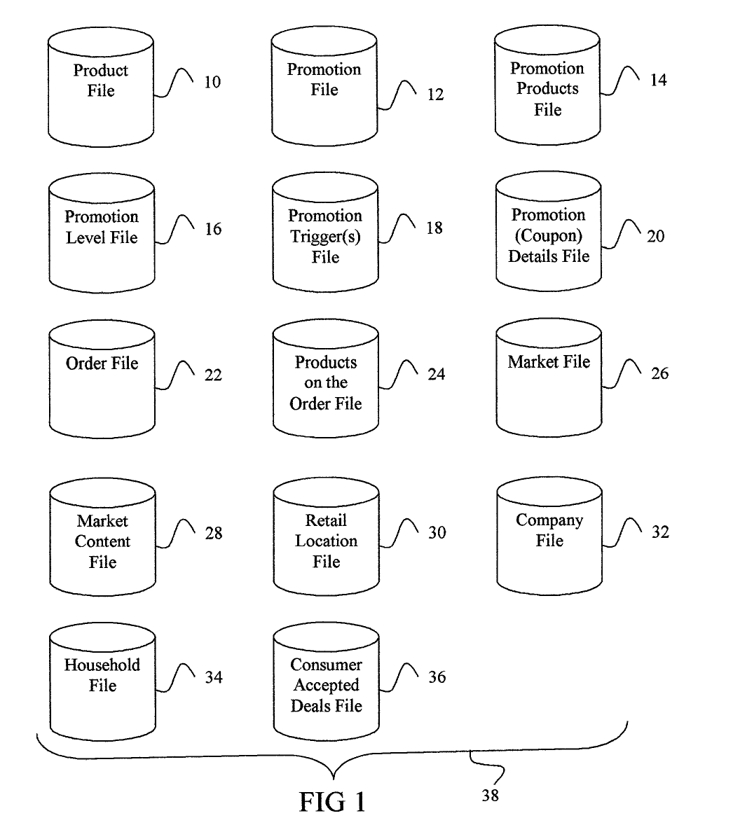

### Description of Invention—FIGS. 1-3

Referring now to the drawings for purposes of illustration, wherein like reference numerals designate identical or corresponding parts throughout the several views, the present invention is concerned with a method for the presentation of promotional offers to a consumer, for selection by the consumer, with the promotion selections stored electronically and the promotional savings delivered directly to the consumer via local printing of the promotion.

FIG. 1 displays a number of files 38 used for such a system. The files include a product file 10, a promotion file 12, a promotional products file 14, a promotion level file 16, a promotion trigger(s) file 18, a promotion (coupon) details file 20, an order file 22, a products on the order file 24, a market file 26, a market content file 28, a retail location file 30, a company file 32 a household file 34, and a consumer accepted deals file 36.

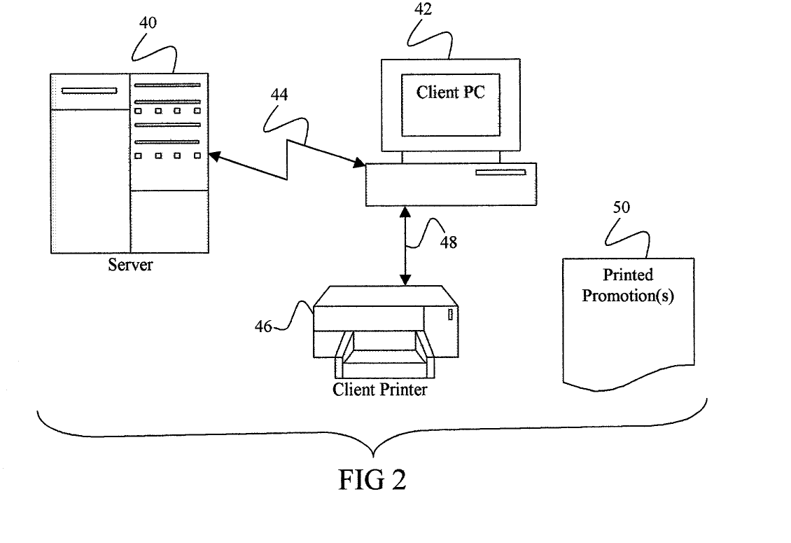

FIG. 2 shows a typical hardware configuration wherein a client PC 42 accesses a server 40 via a communication link 44. The communication link 44 may be a telephone line or some other communication link. The Client PC 42 has a communication link 48 to a Client Printer 46, capable of creating printed promotion(s) 50. In the Preferred Embodiment, the Server 40, Client PC 42 and the communication link 44 are configured as an Internet configuration. However, other configurations may include a Wide Area Network (WAN), Local Area Network (LAN), an Intranet, or some other computer configuration.

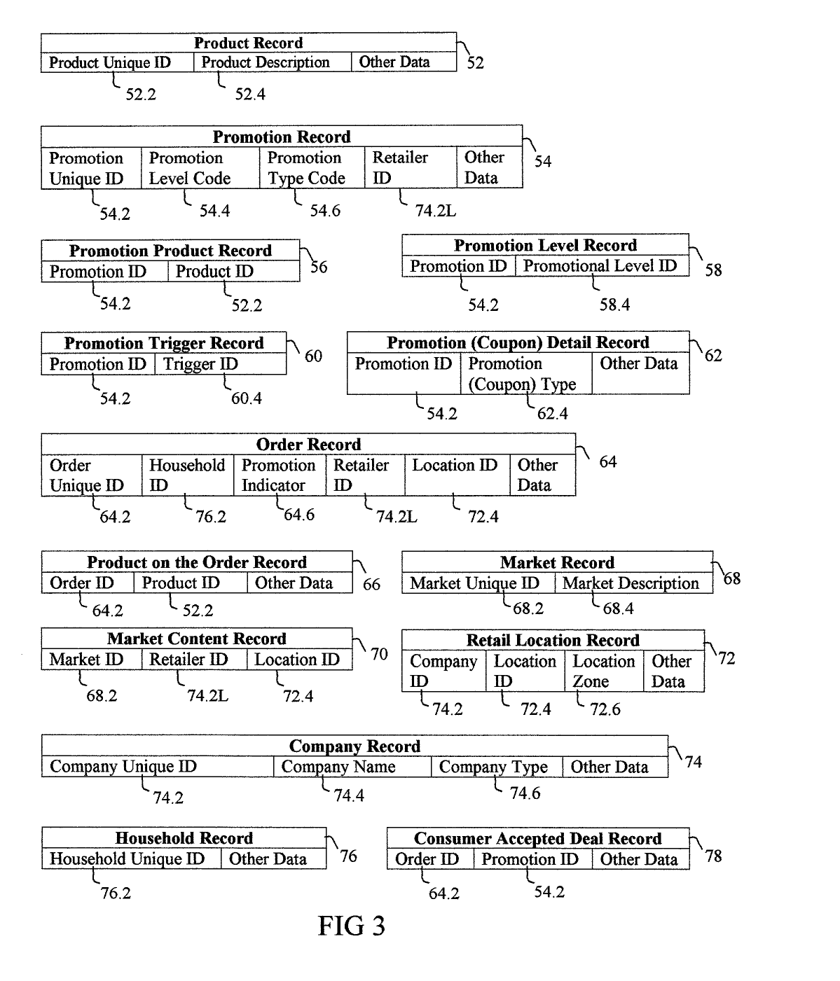

FIG. 3 shows certain records included within the files 38 of FIG. 1.

Product Record:

A product record 52 is stored on the product file 10 and includes a product unique ID 52.2, a product description 52.4 and other data.

Promotion Record:

A promotion record 54 is stored on the promotion file 12 and includes a promotion unique ID 54.2, a promotion level code 54.4, a promotion type code 54.6, a retailer ID 74.2L, and other data.

Promotional Product Record:

A promotion product record 56 is stored on the promotional products file 14 and includes a promotion ID 54.2 and a product ID 52.2. This configuration facilitates the association of anywhere from one to many products to a promotion.

Promotion Level Record:

A promotion level record 58 is stored on the promotion level file 16 and includes a promotion ID 54.2 and a promotion level ID 58.4. This record identifies various level IDs to determine the level at which a promotion is offered. This design allows for one or many level IDs to be associated to a promotion. The promotion level ID 58.4 identifies the level ID to which the promotion is offered, and may indicate a specific retail store, a plurality of related or unrelated stores, a geographic area, a specific retailer, a specific market, a plurality of retailers, a plurality of markets, or all markets available.

Promotion Trigger Record:

A promotion trigger record 60 is stored on the promotion trigger file 18 and includes a promotion ID 54.2 and a trigger ID 60.4. The trigger ID 60.4 may and typically does contain a product ID) 52.2. However, the promotion type code 54.6 of the promotion record 54 having a matching promotions unique ID 54.2 may indicate that the trigger ID 60.4 contains data that is not a product ID. This configuration allows for one or many products to be set as triggers for any number of different promotional offers. Alternately, the design allows for triggers that are not product IDs to be applied to a trigger promotion.

Promotion (Coupon) Detail Record

A promotion (coupon) detail record 62 is stored on the promotion (coupon) detail file 20 and includes a promotion ID 54.2 and a promotion (coupon) type 62.4, and other data.

Order Record:

An order record 64 is stored on the order file 22 and includes an order unique ID 64.2, a household ID 76.2, a promotion indicator 64.6, a retailer ID 72.2L a location ID 72.4, and other data. The promotion indicator 64.6 indicates whether trigger promotions have been reviewed for the order record. The promotion indicator 64.6 may be used to track the number of times triggered promotions have been viewed. The promotion indicator 64.6 provides flexibility in setting limits on the number of times a consumer can view triggered promotions for an order.

Product on the Order Record:

A product on the order record 66 is stored on the products on the order file 24 and includes an order ID 64.2, a product ID 52.2, and other data.

Market Record:

A market record 68 is stored on the market file 26 and includes a market unique ID 68.2, and a market description 68.4.

Market Content Record:

A market content record 70 is stored on the market content file 28 and includes a market ID 68.2, a retailer ID 74.2L and a location ID 72.4.

Retail Location Record:

A retail location record 72 is stored on the retail location file 30 and includes a company ID 74.2, a location ID 72.4, a location zone 72.6, and other data.

Company Record:

A company record 74 is stored on the company file 32 and includes the company unique ID 74.2, a company name 74.4, a company type 74.6, and other data.

Household Record:

A household record 76 is stored on the household file 34 and includes a household unique ID 76.2, and other data.

Consumer Accepted Deals Record:

A consumer accepted deal record 78 is stored on the consumer accepted deals file 36 and includes an order ID 64.2, a promotion ID 54.2, and other data.

Data Record Links:

More specifically FIG. 3 illustrates links between records where the records contain matching data within certain fields. Linked fields are identified by either identical identification numbers or similar identification numbers where the origin of the data is indicated by a number and the linking data has the same number with an “L” suffix.

The product unique ID 52.2 stored in a product record 52 creates a link to the promotion product record 56, and the product on the order record 66. A product unique ID 52.2 may exist only one time within a product record 52 and uniquely identifies product information stored within the product file 10. If a product unique ID 52.2 exists in a promotion product record 56, the product identified by the product unique ID 52.2 is indicated as participating in the promotion identified by the corresponding promotion ID 54.2. The information for the promotion with which the product is associated may be retrieved by matching the promotion product record 56 promotion ID 54.2 to the promotion unique ID 54.2 of the promotion record 54. The same linking method is used in associating a product to an order. A unique order ID 64.2 on the order record 64 uniquely identifies an order record 64 on the order file 22. The unique order ID 64.2, coupled with a product ID 52.2, within the order record 66 identifies a product associated with an order unique ID 64.2 on an order record 64. This construct allows any number of products to be associated with an order or any number of orders.

The promotion unique ID 54.2 stored in a promotion record 54 creates a link to the promotion product record 56, the promotion level record 58, the promotion trigger record 60, the promotion (coupon) detail record 62 and the consumer accepted deal record 78.

The order unique ID 64.2 stored in an order record 64 creates a link to the product on the order record 66, and the consumer accepted deal record 78.

A company is uniquely identified by the company unique ID 74.2 within the company record 74. The company type 74.6 identifies if the company is a retailer. The company unique ID 74.2 of the company record 74 creates a link to the retail location record 72. The company Unique ID 74.2 also links to the market content record 70 when the company unique ID 74.2 matches the retail ID 74.2L of the market content record 70. The same link is created between the company record 74 and the order record 64 when the company unique ID 74.2 matches the retailer ID 74.2L of the order record 64.

The household unique ID 76.2 stored in the household record 76 provides a link to the order record 64. The link is used to identify order information for a specific household.

The location ID 72.4 stored in the retail location record 72 creates a link to the market content record 70, linking a specific location (store) to a market. The location ID 72.4 from the retail location record 72 also links to the location ID 72.4 of the order record 64 to identify the specific retailer store selected for an order.

The market unique ID 68.2 stored in the market record 68 creates a link to the market content record 70. A market unique ID 68.2 from the market record 68, along with a company ID 74.2 and a corresponding location ID 72.4 from the retail location record 72 in the market content file 70 identifies a retail store within the market ID 68.2. A market area may be created with anywhere from one to many retailer locations. The design allows for various stores from various retailers to be contained in the same market.

The data links illustrated above can be created using a number of available database systems capable of supporting the illustrated links (relationships). The system is not limited to any single database system. By way of example, the illustrated data construct is presently implemented using Microsoft® Corporation SQL Server™ 7.0. Relational databases are well known and documented in the industry. Additional information regarding relational database design may be found in the following article at the Microsoft web site: http://support.microsoft.com/support/kb/articles/Q234/2/08.ASP.

### Operation of Invention—FIGS. 1-8

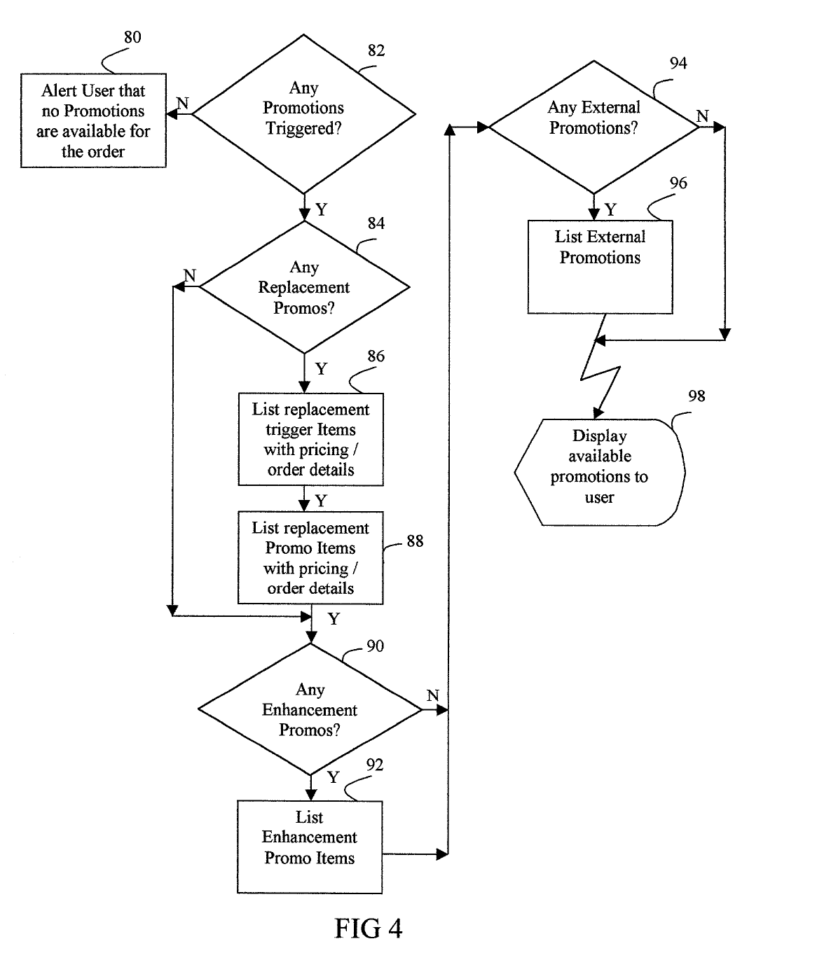

When a consumer starts an order the consumer first selects the store where they wish to shop. A new order record 64 is then created with a new order unique ID 64.2, the household ID 76.2 for the consumer's household, the retailer ID 74.2L for the retailer selected and the location ID 72.4 for the location (store) selected. The consumer adds product on the order records 66 to the products on the order file 24 for each product selected for the order, which places the selected product's ID 52.2, and the current order Id 64.2 into a product on the order record 66. If the promotion indicator 64.6 on the consumer's order record 64 does not exceed any limit placed on the number of times a consumer may review trigger promotions, when the consumer has finished selecting the products desired, the consumer may submit a request to review any promotions triggered as illustrated in block 82 of FIG. 4.

Determine Promotion Availability and Create List for User Selection:

FIG. 4 is a simplified illustration of the process used to determine triggered promotion availability and create a list of triggered promotions. To determine if any promotions have been triggered, as illustrated in the block 82, the product IDs 52.2 on the product on the order records 66 having the consumer's current order ID 64.2 are compared to the trigger IDs 60.4 on the promotion trigger records 60. The corresponding promotion trigger records' 60 promotion Ids 54.2 are then matched to the promotion record 54 having the corresponding promotions unique ID 54.2 and assessed further. The promotion type code 54.6 of the matching promotion record 54 may indicate that a promotion is triggered if any trigger ID 60.4 matches a product ID 52.2 on a product on the order record 66 having the current order ID 64.2. Alternately, the promotion type code 54.6 of the promotion record 54 may indicate that the promotion is triggered if no trigger IDs 60.4 exist in any corresponding product on the order record(s) 66. The promotion type code 54.6 may also indicate that the promotion is triggered by a combination of product IDs 52.2, by an order total or by some other predefined criteria.

Assessment of the Promotional Level:

If promotion criteria are met, the promotion unique ID 54.2 on the promotion record 54 is assessed (the assessed promotion ID). The promotion level code 54.4 on the promotion record 54 indicates how the promotion level ID 58.4 on the promotion level record 58 is evaluated.

By Retailer:

The promotion level code 54.4 may indicate that promotion level records 58 having the assessed promotion ID will have promotional level IDs 58.4 that indicate retailers, where a promotion level record 58 must have the assessed promotion ID and the promotional level ID 58.4 of the promotion level record 58 must match the retailer ID 74.2L listed on the order record 64 for the consumer's current order.

By Retailer Zone:

The promotional level code 54.4 may instead indicate that the promotion is assigned to a retailer's defined marketing area or areas, known as ‘zones’. The promotion level record(s) 58 having the assessed promotion ID will have promotional level IDs 58.4 that indicate retailer zones. The promotion is valid for the consumer if there is a promotion level record 58 having the assessed promotion ID and a promotional level ID 58.4 that matches the location zone 72.6 of a retail location record 72 having a company ID 74.2 matching the order record's retailer ID 74.2L and a location ID 72.4 matching the order record's 64 location ID 72.4. The retailer ID 74.2L of the promotion record 54 may not contain a retailer ID if the promotion is not directed at a single retailer.

By Market:

Alternately, the promotion record's 54 promotion level code 54.4 might indicate the promotion is a market promotion. A market is created by providing a market description 68.4 to correspond to a market unique ID 68.2 in a market record 68. The market unique ID 68.2 from the market record 68 is then placed in the market content file 28 as a new market content record 70. Each market content record 70 has a market ID 68.2 corresponding to a market unique ID 68.2 from a market record 68 along with a retailer ID 74.2L that identifies a retailer and a location ID 72.4 that identifies a location (store) for the specified retailer. A market promotion is determined to be valid for an order if the assessed promotion ID appears in a promotion level record 58 with a corresponding promotion level ID 58.4 that is a market ID 68.2 and the market content file 28 contains a market content record 70 with the same market ID 68.2, and the retailer ID 72.2L and the location ID 72.4 from the order record 64 for the current order unique ID 64.2.

For All Markets:

The promotional level code 54.4 on the promotion record 54 may instead indicate that the promotion is for all markets. All retailers and retail locations are then intended to receive the promotion if the triggering requirement(s) have been fulfilled.

Organize Promotions by Type:

If any promotions have been triggered, the promotion(s) triggered are evaluated to organize them by type as indicated in FIG. 4. The promotion type code 54.6 of the promotion record 54 identifies the promotion type. A check for replacement promotions is executed as indicated in block 84. If replacement promotions have been triggered, a list of replacement trigger items from the promotion trigger(s) file 18, with pricing and order details, will be created as illustrated in block 86. Replacement promotion items from the promotion products file 14 are then listed, with pricing and order details, as indicated in block 88. A check for enhancement promotions is then executed as indicated in block 90. If any enhancement promotions have been triggered, the enhancement items from the promotion products file 14 are listed, with pricing and order details, as illustrated in block 92. A check for external promotions is then executed as indicated in block 94. If any external promotions have been triggered, a list of the external promotions triggered is created as indicated in block 96. Promotional information for all triggered promotions is created using information from the corresponding promotion file 12 and promotion (coupon) details file 20. A display of the triggered promotion(s) is then provided for the consumer's consideration as indicated in block 98. The consumer may select the promotions they wish from the display of triggered promotions. The consumer may enter an order quantity for desired replacement and enhancement promotions, and/or select any external promotions desired. Once reviewed, the consumer's selections are processed.

Process Consumer Promotion Selections:

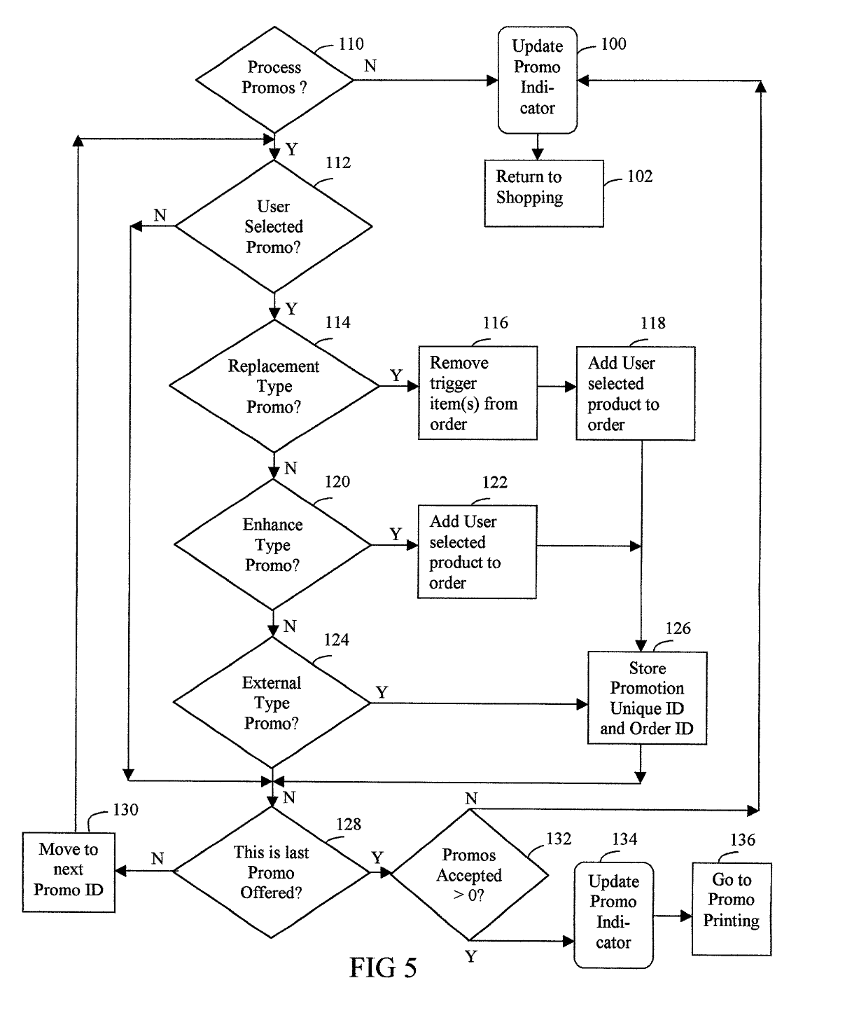

FIG. 5 is a simplified illustration of the method used to process the consumer's promotion selections. Having selected the desired promotions, the consumer may then submit a request to process the promotions as illustrated in block 110. If the consumer elects not to process the promotions 110, the promotion indicator 64.6 may be updated on the order record 64 as indicated by block 100. The consumer is then returned to shopping as illustrated in block 102. The promotion indicator 64.6 is used to identify orders where trigger promotion offers have been viewed. The promotion indicator 64.6 provides the ability to track and therefore limit the number of times a consumer can view triggered promotions.

If the consumer elects to process the promotions as indicated in block 110, each promotion offered is assessed to determine if the consumer has selected the promotion as indicated in block 112. If the consumer has selected the promotion, the promotion type code 54.6 is assessed to determine the type of the promotion selected. If the promotion is a replacement type as indicated in block 114, the products on the order records 66 having product IDs 52.2 that match the trigger IDs 60.4 are removed from the products on the order file 24 as indicated in block 116. The product ID 52.2 and current order ID 64.2 for the consumer-entered promoted product(s) are then added to a product on the order record 66 on the products on the order file 24. If the selected promotion is an enhance type promotion as indicated in block 120, the promoted product is added to a products on the order record 66 on the products on the order file 24 as indicated in block 122. After determining that the consumer selected a promotion and determining the promotion type, the promotion ID 54.2 and order ID 64.2 are stored on a consumer accepted deals record 78. This provides a record of consumer selected promotions. A determination is made if the current promotion is the last promotion offered as illustrated in block 128. If more promotions exist, the next promotion is evaluated as indicated in block 130. The process is repeated until the last promotion offered has been evaluated as indicated in block 128. When the last promotion has been evaluated, the number of promotions selected is assessed as indicated in block 132. If the selected promotion count is greater than zero, the promotion indicator 64.6 on the order record 64 may be updated as indicated by block 134. The promotion indicator 64.6 is used to identify orders where trigger promotion offers have been viewed. The promotion indicator 64.6 provides the ability to track and therefore limit the number of times a consumer can view triggered promotions. The selected promotions will then be forwarded for client PC printing as indicated in block 136.

Create the Printable Promotions:

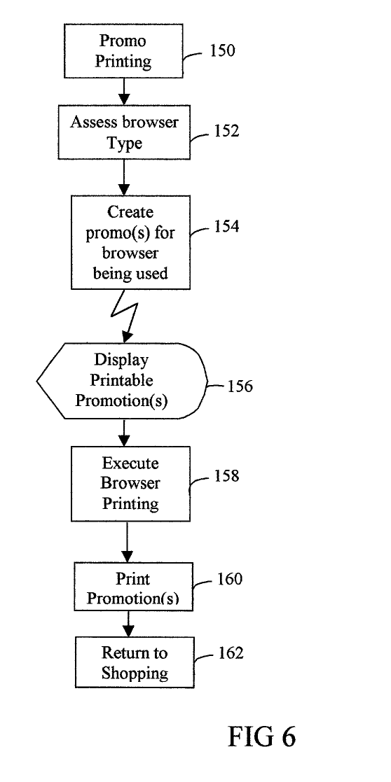

FIG. 6 is an illustration of the method used to create the printable promotion(s). The consumer's Internet browser is assessed as indicated in block 152. Printable promotions are created using methods consistent with the capabilities of the identified browser to allow the browser to most accurately print the promotional offers selected by the consumer as indicated in block 154. The printable promotions are then displayed on the consumer's client PC as indicated in block 156. The browser's print command is executed as indicated in block 158 and the consumer selected promotions are printed on the consumer's printer as indicated in block 160. The consumer may then return to shopping as indicated in block 162.

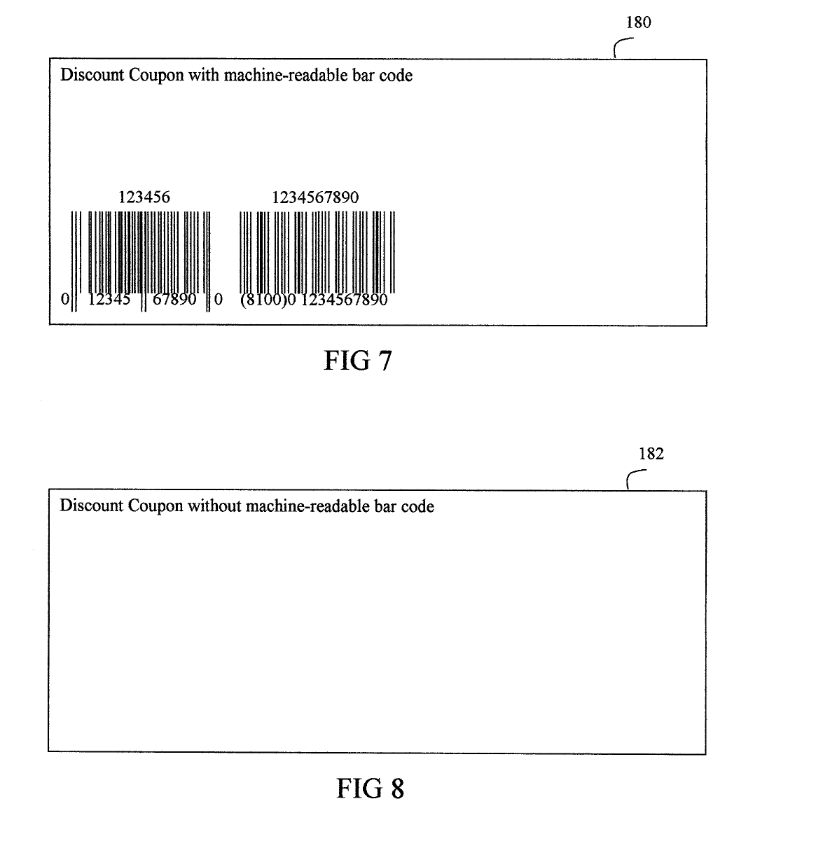

The printed promotions may take several forms based on the promotion type and the data stored in the promotion (coupon) detail record 62. FIG. 7 illustrates a printed, machine-readable promotion 180 created if a selected promotion requires a machine-readable bar code to provide the consumer with the value offered by a promotion. The machine-readable promotion 180 is typical of a consumer packaged product coupon. FIG. 8 illustrates a printed promotion without a machine-readable bar code 182 that may be printed and used in the event a promotion does not require, or a company cannot support, the data necessary to create a machine-readable promotion. The printed promotion without a machine-readable bar code 182 is typical of regional company coupons such as automotive care companies, local restaurants, home care services, dry cleaners and others.

Conclusion, Ramifications, and Scope of Invention

The present invention is a substantial advancement in the delivery of promotional offers to consumers. In particular, the invention provides a means to deliver specifically focused promotional offers to consumers in real time, in response to planned product purchases before a sale has actually occurred. This method allows promoting companies to reach consumers that are far more likely to have interest in the promotion offered. The invention is the only current method that allows the targeted consumer to participate in the selection of promotions that have been targeted based on the consumer's planned purchases. This methodology allows promoting companies to reach consumers before the consummation of a planned purchase, thereby allow the promoting company the opportunity to influence purchase decisions during the consumer purchasing decision process. The invention stores the information of, and prints using a local printer, promotions that have been actively selected by the consumer. This method significantly increases the likelihood that the consumer will redeem the printed promotion. The invention significantly reduces misdirected promotional costs incurred by promoting companies when using the current art available. By targeting promotions based on products selected by a consumer in real-time, the potential risks of targeting a household that has experienced a tragic loss, e.g. the death of a child, have been eliminated. A household that intends to purchase diapers has a high probability of having an interest in similar or related baby products. The financial and material waste incurred by the current art methods available are significantly reduced. With this promotional delivery system, a promoting company has, for the first time, the opportunity to direct a promotion to a consumer who has indicated an intention to purchase a direct competitors product.

While the above description contains many specificities, these should not be construed as limitations on the scope of the invention, but rather as exemplary of one preferred embodiment. Many other variations are possible. For example, the electronic storage of the consumer selected promotional information could be leveraged to allow for electronic redemption of the consumer selected promotional offer, rather than the physical printing of the promotion. This electronic record of the consumer-selected promotion could be used to process the promotion electronically by any system capable of retrieving the electronically stored information. This provides for the electronic recognition of the stored promotional value within any number of retail and or service environments. Environments that might leverage the electronic record might include traditional retail or service environments, electronic retail or service environments, a combination of traditional and electronic environments or other environments.

Additionally, the invention could be configured within a different technical environment, for example, in a kiosk arrangement at a single location or in a plurality of locations. Such an arrangement might place all the necessary data and functionality within a local environment.

The invention could also be leveraged to provide a number of promotional vehicles. Interrelated products could be used to trigger a promotional offer e.g. the purchase of more than one element necessary for a recipe could create an offer for another element or additional elements of the recipe. Groups of products might be used to provide a promotion on a common event e.g. a group of manufacturers supporting a sporting event might provide a promotion for a reduced price on tickets if a consumer has purchased an item from a designated list of products for each of the manufacturers involved in the support of the event. Continuity promotions might be offered if a consumer has purchased a designated number of the same product. A loyalty promotional could be offered if a consumer has displayed a history, over time, of purchasing or not purchasing a product. Various promotions or incentives might be delivered for orders having reached certain totals. Alternately, the invention could deliver a default promotion to a consumer wherein the promotion is delivered when criteria has been met but without the consumer actively selecting the promotion. The design of the related records allows for unlimited promotional types. The creation of new promotional type codes, with associated requirements for the new promotional types created, allows for unlimited flexibility for the development of new promotional types.

In light of the above teachings, and the inherent flexibility designed therein, numerous modifications and variations of the present invention are possible. Therefore, it is to be understood that the scope of the invention should be determined by the appended claims and their legal equivalents, rather than by the examples provided herein.

1. A method for delivery of a promotional offer to a consumer comprising;
(a) means for storing criteria for said promotional offer;
(b) providing a computer printer;
(c) means for storing content of a consumer created order;
(d) means for identifying said promotional offer where said criteria of said promotional offer have been met based on said content of a consumer created order;
(e) providing a display for the display of said promotional offer where said criteria of said promotional offer have been met;
(f) means for consumer to select said promotional offer by review of said display of said promotional offer;
(g) means for printing the consumer selected promotional offer via said computer printer; and
whereby said computer printer prints said promotional offer solely in response to the consumer's selection of the promotional offer.

2. The method of claim 1 wherein the printed promotional offer has a machine-readable barcode.

3. The method of claim 1 wherein the printed promotional offer does not have a machine-readable barcode.

4. A method for delivery of a promotional offer to a consumer comprising;
(a) means for storing criteria for said promotional offer;
(b) providing a computer printer;
(c) means for storing content of a consumer created order;
(d) means for identifying said promotional offer where said criteria of said promotional offer have been met based on said content of a consumer created order;
(e) means for printing said promotional offer via said computer printer; and
whereby the printing of said promotion is solely in response to said criteria of said promotional offer having been met.

5. The method of claim 4 wherein the printed promotional offer has a machine-readable barcode.

6. The method of claim 4 wherein the printed promotional offer does not have a machine-readable barcode

7. A method for delivery of a promotional offer to a consumer comprising;
(a) means for storing criteria for said promotional offer;
(b) means for storing consumer information;
(c) means for storing content of a consumer created order;
(d) means for identifying said promotional offer where the criteria of the promotional offer have been met based on the said content of a consumer created order;
(e) providing a display for the display of said promotional offer where said criteria of said promotional offer have been met;
(f) means for consumer to select said promotional offer by review of said display of said promotional offer;
(g) means for storing the selected promotional offer;
whereby the storage of said promotional offer is solely in response to the consumer's selection of the promotional offer; and
whereby the stored consumer-selected promotional offer may be retrieved electronically for use at a retail store.

8. A method for delivery of a promotional offer to a consumer comprising;
(a) means for storing criteria for said promotional offer;
(h) means for storing consumer information;
(b) means for storing content of a consumer created order;
(c) means for identifying said promotional offer where said criteria of said promotional offer have been met based on said content of a consumer created order;
(d) means for storing the identified promotional offer;
whereby the storage of said promotional offer is solely in response to said criteria of said promotional offer having been met; and
whereby the promotional offer may be retrieved electronically for use at a retail store.
